(19) United States
(12) Patent Application Publication
(10) Pub. No.: US 2015/0086445 A1
(43) Pub. Date: Mar. 26, 2015

(54) FLUID INJECTION CHIP

(71) Applicant: SAMSUNG ELECTRO-MECHANICS CO., LTD., Suwon (KR)

(72) Inventors: Dong Woo LEE, Suwon (KR); Bo Sung Ku, Suwon (KR)

(73) Assignee: SAMSUNG ELECTRO-MECHANICS CO., LTD., Suwon (KR)

(21) Appl. No.: 14/143,833

(22) Filed: Dec. 30, 2013

(30) Foreign Application Priority Data
Sep. 25, 2013 (KR) 10-2013-0113837

(51) Int. Cl. B01L 3/00

(52) U.S. Cl. CPC B01L 3/5027
USPC 422/503

(57) ABSTRACT

There is provided a fluid injection chip including: a first substrate in which a plurality of wells are formed; a first fluid formed in the wells; a second substrate of which a plurality of pillar members are formed on a lower surface so as to correspond to the wells; a low adhesive layer formed on a protrusion surface of the pillar member; and a second fluid formed on the low adhesive layer.

### CROSS-REFERENCE TO RELATED APPLICATION

This application claims the benefit of Korean Patent Application No. 10-2013-0113837 filed on Sep. 25, 2013, with the Korean Intellectual Property Office, the disclosure of which is incorporated herein by reference.

### BACKGROUND

The present disclosure relates to a fluid injection chip capable of simultaneously injecting a trace amount of fluid into a plurality of wells simultaneously.

The demand for biomedical apparatuses and general biotechnology for rapidly diagnosing various human diseases has recently increased. Accordingly, the development of biosensors and biochips capable of providing relatively rapid diagnosis results for specific diseases that previously required a relatively long period of time to obtain from a hospital or a research laboratory has been actively undertaken.

Research into such biosensors and biochips has also been demanded in pharmaceutical companies, cosmetics companies, and the like, in addition to hospitals. In the pharmaceutical field, the cosmetics field, and the like, a method of verifying the effectiveness and stability (toxicity) of a specific drug by inspecting a reaction of a cell to the specific drug has been used. Since the method according to the related art should use animals or a large amount of a reagent, high costs and relatively long periods of time have been required for testing.

Therefore, the development of a biosensor or a biochip capable of rapidly and accurately diagnosing diseases while simultaneously reducing associated costs has been demanded.

Biochips may be divided into DNA chips, protein chips, and cell chips, according to the kind of biomaterials fixed to a substrate. In the early stage, as understanding of human genetic information has increased, DNA chips have been increasingly prominent. However, as interest in proteins maintaining vital activity and cells, protein conjugates which are at the core of all living things has increased, interest in protein chips and cell chips has correspondingly increased.

Protein chips initially had difficulties such as non-selective adsorption, but methods for solving such difficulties have recently been suggested.

Cell chips, effective mediums capable of being applied to various fields such as new medicine development, genomics, proteomics, and the like, have been prominent.

In the case of the biochip as described above, in order to supply nutrients to a target substance such as cells, or the like, or to prevent contamination, a process of injecting a drug into a specific well or replacing a culture medium is required.

For accuracy in experimentation, it is important to inject the drug into each of the wells while significantly decreasing a time difference between injections.

However, 96 to 1566 or more wells may be formed in a single chip due to the development of a high-speed large capacity analysis system, such that it may take a relatively long time to inject the drug into each of the wells.

That is, since there is a time difference of at least 5 minutes between the time at which the drug is injected into the first well and the time at which the drug is injected into the last well, the drug may be evaporated, or a response caused by the drug may have already proceeded, such that accuracy of the experiment may be deteriorated.

That is, since this time difference is a main cause of decreased accuracy in protein response tests, as well as in cell response tests, a technology of rapidly and accurately injecting a drug into each of the wells at the same time has been demanded.

A disclosure associated with a cell chip was disclosed in the following Related Art Document (Patent Document 1), but an apparatus for injecting a fluid using a low adhesive layer as in the present disclosure was not disclosed therein.

That is, the disclosure disclosed in Patent Document 1 relates to a biomaterial fixed to a substrate in a three dimensional form to thereby not be mixed with a fluid in a well and is different from the present disclosure in that the fluid is injected using the low adhesive layer in the present disclosure.

### RELATED ART DOCUMENT

(Patent Document 1) Korean Patent Laid-open Publication No. 2001-0039377

### SUMMARY

An aspect of the present disclosure may provide a fluid injection chip capable of simultaneously injecting a trace amount of fluid into a plurality of wells simultaneously.

According to an aspect of the present disclosure, a fluid injection chip may include: a first substrate in which a plurality of wells are formed; a first fluid formed in the wells; a second substrate of which a plurality of pillar members are formed on a lower surface so as to correspond to the wells; a low adhesive layer formed on a protrusion surface of the pillar member; and a second fluid formed on the low adhesive layer.

The fluid injection chip may further include a vibration member formed on an upper surface of the second substrate.

The low adhesive layer may be formed of a hydrophobic material.

The second fluid may be simultaneously injected into the plurality of wells.

According to another aspect of the present disclosure, a fluid injection chip may include: a first substrate in which a plurality of wells are formed; a first fluid formed in the wells; a second substrate of which a plurality of pillar members are formed on a lower surface so as to correspond to the wells; a fluid injection part formed in a side surface of the pillar member; and a second fluid formed in the fluid injection part.

The fluid injection chip may further include a vibration member formed on an upper surface of the second substrate.

The fluid injection chip may further include a low adhesive layer formed on a surface of the fluid injection part.

The low adhesive layer may be formed of a hydrophobic material.

A protrusion surface of the pillar member may have a curvature.

The second fluid may be simultaneously injected into the plurality of wells.

According to another aspect of the present disclosure, a fluid injection chip may include: a first substrate in which a plurality of wells are formed; a first fluid formed in the wells; a second substrate of which a plurality of pillar members are formed on a lower surface so as to correspond to the wells; and a second fluid formed on the low adhesive layer, wherein the pillar member is formed of a hydrophobic material.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a schematic perspective view of a fluid injection chip according to an exemplary embodiment of the present disclosure, and FIG. 2 is a schematic cross-sectional view taken along line A-A′ of FIG. 1;

FIGS. 3 and 4 are photographs of stained cells obtained by injecting a fluid using the fluid injection chip according to the exemplary embodiment of the present disclosure and staining cells reacting with the injected fluid;

FIG. 5 is a schematic cross-sectional view of a fluid injection chip according to the exemplary embodiment of the present disclosure, further including a vibration member;

FIG. 6 is a schematic perspective view of a fluid injection chip according to another exemplary embodiment of the present disclosure, and FIG. 7 is a schematic cross-sectional view taken along line B-B′ of FIG. 7;

FIG. 8 is a schematic cross-sectional view of a fluid injection chip according to another embodiment of the present disclosure, further including a low adhesive layer formed on a surface of a fluid injection part;

FIG. 9 is a schematic cross-sectional view of a fluid injection chip according to another exemplary embodiment of the present disclosure, further including a vibration member; and

FIG. 10 is a schematic cross-sectional view of a fluid injection chip of which a protrusion surface of a pillar member has a curvature.

### DETAILED DESCRIPTION

Hereinafter, embodiments of the present invention will be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art. In the drawings, the shapes and dimensions of elements may be exaggerated for clarity, and the same reference numerals will be used throughout to designate the same or like elements.

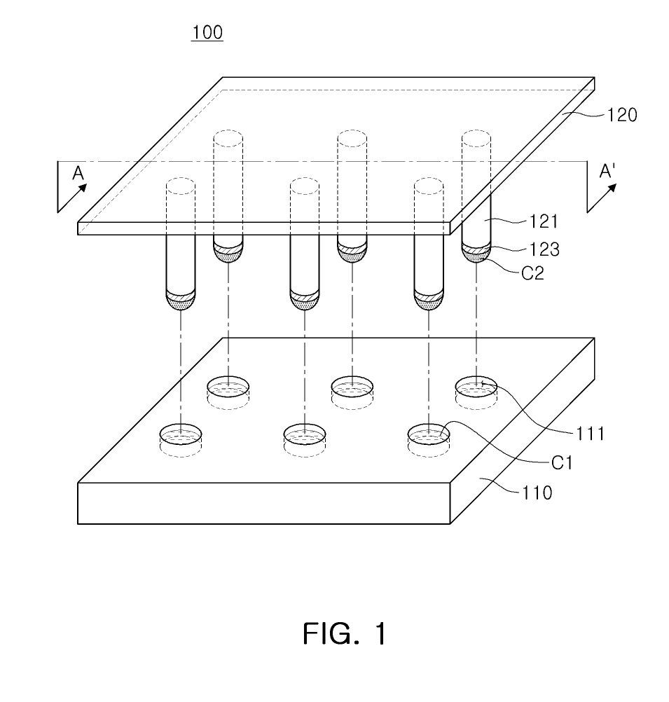

FIG. 1 is a schematic perspective view of a fluid injection chip 100 according to an exemplary embodiment of the present disclosure, and FIG. 2 is a schematic cross-sectional view taken along line A-A′ of FIG. 1.

Describing a structure of the fluid injection ship 100 according to the exemplary embodiment of the present disclosure with reference to FIGS. 1 and 2, the fluid injection chip according to the exemplary embodiment of the present disclosure may be configured of a first substrate 110 including wells 111 formed therein and a second substrate 120 including pillar members 121 formed thereon.

More specifically, the fluid injection chip 100 according to the exemplary embodiment of the present disclosure may include the first substrate 110 in which a plurality of wells 111 are formed; a first fluid C1 formed in the wells 111; and the second substrate 120 of which a plurality of pillar members 121 are formed on a lower surface so as to correspond to the wells 111; a low adhesive layer 123 formed on a protrusion surface of the pillar member 121; and a second fluid C2 formed on the low adhesive layer 123.

The wells 111 may be formed so as to have a predetermined interval therebetween.

The wells 111 may be formed by partially removing the first substrate 110. More specifically, the wells 111 may be formed by partially etching the first substrate 110.

In addition, the wells 111 may be formed by erecting partitions on the first substrate 110.

The first fluid C1 for culturing cells or testing reactivity to a specific drug may be formed in the wells 111.

The first fluid C1 may be a biomaterial.

The kind of biomaterial is not particularly limited, but may be, for example, a nucleic acid arrangement such as RNA, DNA, or the like, peptides, proteins, fats, organic or inorganic chemical molecules, virus particles, prokaryotic cells, organelles, or the like.

More specifically, the biomaterial may be cells in a culture medium or enzyme.

In addition, the kind of cell is not particularly limited, but may be, for example, a microorganism, a plant or animal cell, a tumor cell, a neural cell, an endovascular cell, an immune cell, or the like.

The biomaterial may be dispersed in a dispersion material capable of maintaining organization and functions of the biomaterial and formed on a bottom surface of the wells 111.

The dispersion material may be a porous material through which a reagent such as a culture medium, a specific drug, various aqueous solutions, or the like, may penetrate. Examples of the dispersion material may include sol-gel, hydro gel, alginate gel, organogel or xerogel, gelatin, collagen, or the like, but is not limited thereto.

The biomaterial may be dispersed in the dispersion material to thereby be attached to the bottom surface of the wells 111 in a three dimensional structure. Since the biomaterial having the three-dimensional structure is more similar to a bio-environment, more accurate test results may be obtained.

The pillar member 121 may be formed on the second substrate 120 so as to correspond to the wells 111.

That is, when the first and second substrates 110 and 120 are combined with each other, the pillar member 121 may be positioned in the wells 111.

The pillar member 121 may be formed so as to have a length shorter than a depth of the wells 111, but is not limited thereto.

In the case in which the pillar member 121 is formed so as to have a length longer than the depth of the wells 111, the pillar member 121 may be interposed between the first and second substrates 110 and 120 like a gasket, such that the height thereof may be adjusted.

The pillar member 121 may be formed of a hydrophobic material.

The protrusion surface of the pillar member 121 may be provided with the low adhesive layer 123.

The low adhesive layer 123 may be formed by coating a different material according to the kind of second fluid C2, but is not limited thereto.

The second fluid C2 may be a drug, an enzyme, cells, or the like.

The low adhesive layer 123 may be formed of a hydrophobic material so that the second fluid C2 may be easily injected into the first fluid C1.

The hydrophobic material may be at least one of polytetrafluoroethylene (PTFE), polystyrene, and a mixture thereof, but is not limited thereto.

Since the low adhesive layer 123 is formed using a material capable of easily allowing for the detachment of the second fluid C2 from the low adhesive layer 123, when the first and second substrates 110 and 120 are combined with each other after the second fluid C2 is formed on the low adhesive layer 123, the second fluid C2 may be simultaneously injected into the plurality of wells 111.

Recently, as a high-speed large capacity analysis system has been developed, a cell chip has also developed from a form in which 96 wells are formed in a single chip into a form in which 384 wells or 1,536 or more wells are formed in a single chip. However, there are problems in that a relatively long period of time may be consumed in injecting a fluid into a plurality of wells used in the high-speed large capacity analysis system, and bubbles may be generated due to surface tension at the time of injecting a trace amount of fluid.

Generally, an amount of the second fluid C2 injected into the wells 111 of the cell chip used in the high-speed large capacity analysis system may be 0.001 to 100 W, which is a significantly small amount.

In detail, since an amount of the first fluid C1 formed in the well is about 950 nl, and an injection amount of the second fluid C2 is about 50 nl, the amount of the second fluid C2 may be relatively significantly small as compared to the first fluid C1.

In the case of directly and individually injecting the second fluid C2 into at least 96 to at most 1,536 wells, there is a time difference of at least 5 minutes between a time at which the second fluid C2 is injected into a first well among wells 111 and a time at which the second fluid C2 is injected into a last well among wells 111.

That is, a fluid C of the wells 111 into which the second fluid is first injected may be evaporated due to the above-mentioned time difference and the trace injection amount of the second fluid C2 before injecting the second fluid C2 into all of the wells 111.

In addition, a reaction degree of the first fluid C1 formed in the wells 111 into which the second fluid C2 is first injected with the second fluid C2 may be different from a reaction degree of the first fluid C1 of the wells 111 into which the second fluid C2 is finally injected with the second fluid C2 due to the above-mentioned time difference.

Further, in the case of directly and individually injecting the second fluid C2 into at least 96 to at most 1,536 wells 111 using a pipette, or the like, bubbles may be generated in the wells 111 due to surface tension, which may cause an experimental error.

Therefore, in the case of directly and individually injecting the second fluid C2 into the wells 111, reliability and accuracy of the large capacity analysis system may be significantly decreased due to evaporation of the first fluid C1 and a difference in reaction of the first and second fluids C1 and C2 which are caused by a difference in the injection time and bubble generation in the first fluid C1.

However, in the case of using the fluid injection chip 100 according to the exemplary embodiment of the present disclosure, since the second fluid C2 may be simultaneously injected into the plurality of wells 111, the reliability and accuracy of the large capacity analysis system may be significantly improved.

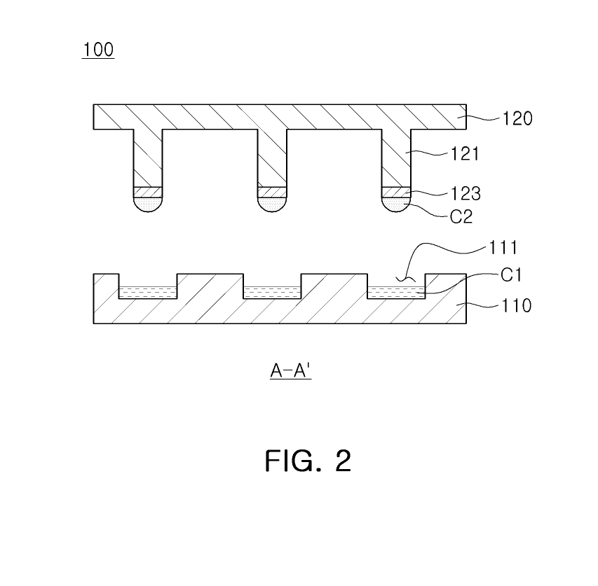

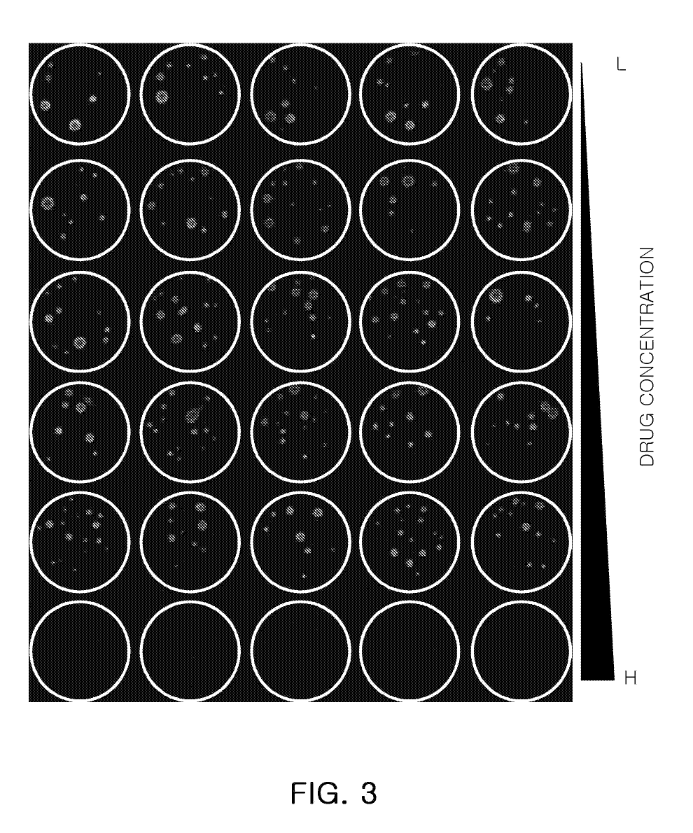

FIGS. 3 and 4 are photographs of stained cells obtained by injecting a drug using the fluid injection chip 100 according to the exemplary embodiment of the present disclosure and staining cells reacting with the drug.

In FIG. 3, a white circle indicates a well among the wells 111, and a grey portion in the well among the wells 111 indicates cells reacting with the drug.

FIG. 4 is photograph of stained cells obtained by injecting the drug using the fluid injection chip 100 according to the exemplary embodiment of the present disclosure into 514 wells 111 except for 28 wells 111 at both ends among 532 wells 111 and then staining cells reacting with the drug.

Results of FIGS. 3 and 4 are almost equal to that of a fluid injection chip 200 according to another exemplary embodiment to be described below.

In the fluid injection chip 100 according to the exemplary embodiment of the present disclosure, the low adhesive layer 122 may be formed on the protrusion surfaces of the plurality of pillar members 121, and the second fluid C2 may be formed on a lower surface of the low adhesive layer 122.

Therefore, in the case of combining the first and second substrates 110 and 120 with each other, the plurality of pillar members 121 may simultaneously penetrate into the plurality of wells 111 to thereby inject the second fluid C2.

Therefore, a time difference in injecting the second fluid C2 into the first fluid C1 formed in each of the wells 111 is not generated, such that reliability and accuracy of the large capacity analysis system may be significantly improved.

Referring to FIG. 3, it may be appreciated that sizes and the number of stained cells are similar to each other at other portions except for a portion H having a highest drug concentration.

Since cells died due to the high concentration drug, cells are not shown in the portion H having the highest drug concentration.

It may be appreciated that in the remainder of portions, except for the portion H, the number and sizes of cells may be almost similar to each other without a difference according the position of the wells 111.

Therefore, in the case of using the fluid injection chip 100 according to the exemplary embodiment of the present disclosure, the second fluid C2 may be simultaneously injected into the plurality of wells 111.

Referring to FIG. 4, it may be appreciated that even in the case in which the number of wells 111 is 514, a reaction degree of the cell with the drug is not changed according to the position.

That is, the fluid injection chip 100 according to the exemplary embodiment of the present disclosure may simultaneously inject the second fluid C2 into the plurality of wells 111 regardless of the position of the wells 111.

Therefore, a time difference in injecting the second fluid C2 into each of the wells 111 is not generated, such that reliability and accuracy of the large capacity analysis system may be significantly improved.

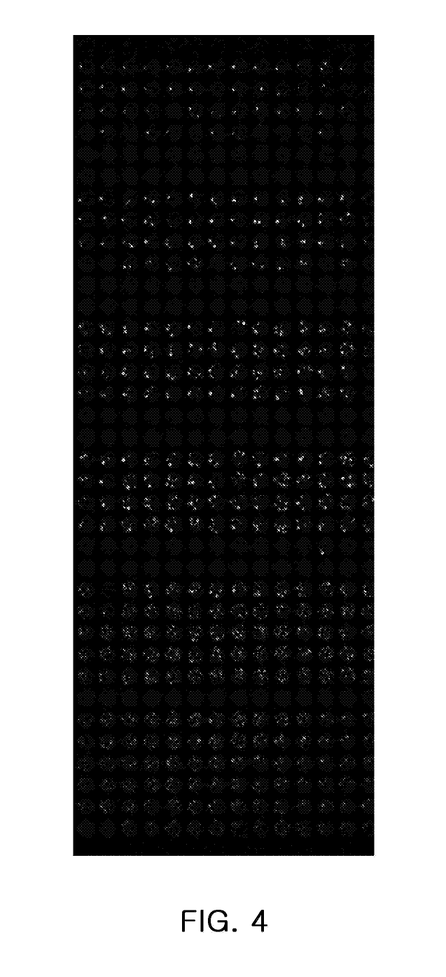

FIG. 5 is a schematic cross-sectional view of a fluid injection chip 100 according to the exemplary embodiment of the present disclosure, further including a vibration member 130.

The vibration member 130 may be formed on an upper surface of the second substrate 120.

The vibration member 130 may be formed of a material capable of generating vibrations.

More specifically, the vibration member 130 may be formed using an ultrasonic generator, a piezoelectric material, or the like, but is not limited thereto.

The vibration member 130 may generate vibrations in the pillar member 121 to thereby more easily inject the second fluid C2 formed on the low adhesive layer 123 into the wells 111.

In addition, the vibration member 130 may generate vibrations in the pillar member 121 to allow the second fluid C2 to be more suitably dispersed in the wells 111 when the second fluid C2 is injected into the wells 111.

Therefore, the vibration member 130 may significantly improve the reliability and accuracy of the large capacity analysis system.

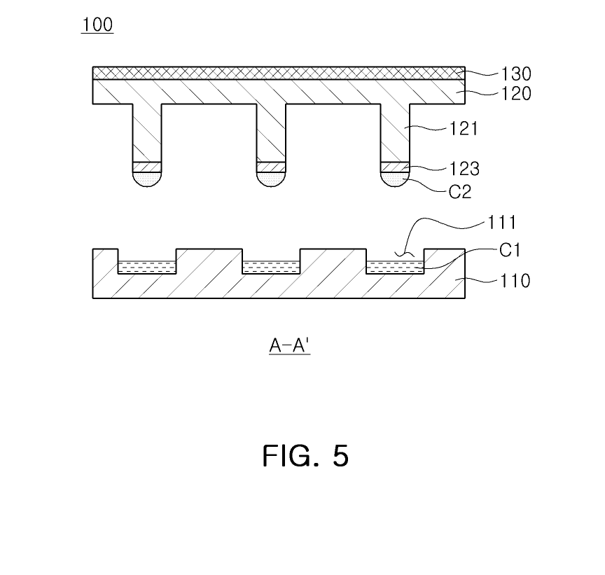

FIG. 6 is a schematic perspective view of a fluid injection chip 200 according to another exemplary embodiment of the present disclosure, and FIG. 7 is a schematic cross-sectional view taken along line B-B′ of FIG. 7.

Describing a structure of the fluid injection ship 200 according to another exemplary embodiment of the present disclosure with reference to FIGS. 6 and 7, the fluid injection chip according to another exemplary embodiment of the present disclosure may be configured of a first substrate 210 including wells 211 formed therein and a second substrate 220 including pillar members 221 formed thereon.

More specifically, the fluid injection chip 200 according to another exemplary embodiment of the present disclosure may include the first substrate 210 in which a plurality of wells 211 are formed; a first fluid C1 formed in the first substrate 210; the second substrate 220 of which a plurality of pillar members 221 are formed in a lower surface so as to correspond to the wells 211; a fluid injection part 222 formed in a side surface of the pillar member 221; and a second fluid C2 formed in the fluid inject part 222.

The wells 211 may be formed so as to have a predetermined interval therebetween.

The well 211 may be formed by partially removing the first substrate 210. More specifically, the well 211 may be formed by partially etching the first substrate 210.

In addition, the well 211 may be formed by erecting partitions on the first substrate 210.

The first fluid C1 for culturing cells or testing reactivity to a specific drug may be formed in the well 211.

The first fluid C1 may be a biomaterial.

A kind of biomaterial is not particularly limited but may be, for example, a nucleic acid arrangement such as RNA, DNA, or the like, peptides, proteins, fats, an organic or inorganic chemical molecule, virus particles, prokaryotic cells, organelles, or the like.

In addition, the kind of cell is not particularly limited, but may be, for example, a microorganism, a plant or an animal cell, a tumor cell, a neural cell, an endovascular cell, an immune cell, or the like.

The first fluid C1 may be dispersed in a dispersion material capable of maintaining organization and functions of the biomaterial and formed on a bottom surface of the well 211.

The dispersion material may be a porous material through which a reagent such as a culture medium, a specific drug, various aqueous solutions, or the like, may penetrate. Examples of the dispersion material may include sol-gel, hydro gel, alginate gel, organogel or xerogel, gelatin, collagen, or the like, but is not limited thereto.

The first fluid C1 may be dispersed in the dispersion material to thereby be attached to the bottom surface of the well 211 in a three dimensional structure. Since the biomaterial having the three-dimensional structure is more similar to a bio-environment, more accurate test results may be obtained.

The pillar member 221 may be formed on the second substrate 220 so as to correspond to the well 211.

That is, when the first and second substrates 210 and 220 are combined with each other, the pillar member 221 may be positioned on the well 211.

The pillar member 221 may be formed so as to have a length shorter than a depth of the well 211, but is not limited thereto.

In the case in which the pillar member 221 is formed so as to have a length longer than the depth of the well 211, the pillar member 221 may be interposed between the first and second substrates 110 and 120 like a gasket, such that the height may be adjusted.

The fluid injection part 222 may be formed in the side surface of the pillar member 221.

The fluid injection part 222 may be formed by etching along the side surface of the pillar member 220 at a predetermined depth, but is not limited thereto.

For example, the fluid injection part 222 may be formed by drilling a hole in the side surface of the pillar member 221.

In the fluid injection chip 200 according to another exemplary embodiment of the present disclosure, since the fluid injection part 222 is formed in the side surface rather than a protrusion surface of the pillar member 221, an amount of the second fluid C2 may be more accurately adjusted as compared to the fluid injection chip 100 according to the exemplary embodiment of the present disclosure.

That is, the second fluid C2 may only be formed in the fluid injection part 222 by making the protrusion surface of the pillar member 221 contact a material such as dried paper and then be separated from the material after the pillar member 221 is dipped into a drug to form the second fluid C2 in the fluid injection part 222.

Since an amount of the first fluid C1 formed in the well 211 is about 950 nl, and an amount of the second fluid C2 is about 50 nl, the amount of the second fluid C2 may be relatively significantly small as compared to the first fluid C1.

Therefore, in the case in which the second fluid C2 is formed at an undesired portion, an amount of the injected second fluid C2 may be changed, such that accuracy and reliability of the experiment may be decreased.

However, since in the fluid injection chip 200 according to another exemplary embodiment of the present disclosure, the second fluid C2 may be accurately formed only in the fluid injection part 222, accuracy and reliability of the experiment may be increased.

In addition, as described in the fluid injection chip 100 according to the exemplary embodiment of the present disclosure, in the fluid injection chip 200 according to another exemplary embodiment of the present disclosure, since a time difference in injecting the second fluid C2 into the first fluid C1 formed in the plurality of wells 211 is not generated, the reliability and accuracy of the large capacity analysis system may be significantly improved.

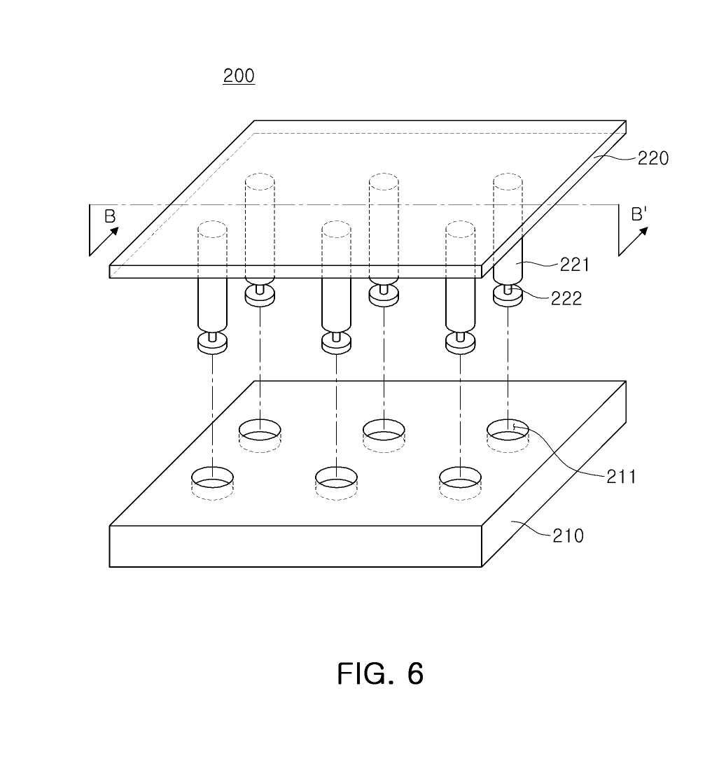

FIG. 8 is a schematic cross-sectional view of a fluid injection chip 200 according to another embodiment of the present disclosure, further including a low adhesive layer 223 formed on a surface of the fluid injection part 222.

The low adhesive layer 223 may be formed in fluid injection part 222 of the pillar member 221.

The low adhesive layer 223 may be formed by coating a different material according to the kind of second fluid C2, but is not limited thereto.

The low adhesive layer 223 may be formed of a hydrophobic material so that the second fluid C2 may be easily injected into the well 211.

The hydrophobic material may be at least one of polytetrafluoroethylene (PTFE), polystyrene, and a mixture thereof, but is not limited thereto.

Since the low adhesive layer 223 is formed using a material capable of easily allowing for the detachment of the second fluid C2 from the low adhesive layer 223, when the first and second substrates 210 and 220 are combined with each other after the second fluid C2 is formed on the low adhesive layer 223, the second fluid C2 may be simultaneously injected into the first fluid C1 formed in the plurality of wells 211.

Recently, as a high-speed large capacity analysis system has been developed, a cell chip has also developed from a form in which 96 wells are formed in a single chip to a form in which 384 wells or at least 1,536 wells are formed in a single chip. However, there are problems in that a relatively long period of time may be consumed to inject a drug into a plurality of wells used in the high-speed large data analysis system, and bubbles may be generated due to surface tension at the time of injecting a trace amount of fluid.

Since an amount of the first fluid C1 formed in the well is about 950 nl, and an injection amount of the second fluid C2 is about 50 nl, the amount of the second fluid C2 may be relatively significantly small as compared to the first fluid C1.

In the case of directly and individually injecting the second fluid C2 into the first fluid C1 in at least 96 to at most 1,536 wells, there is a time difference of at least 5 minutes between a time at which the second fluid C2 is first injected into the first fluid C1 and a time at which the second fluid C2 is last injected into the first fluid C1.

That is, the first fluid C of the well 211 into which the second fluid C2 is first injected may be evaporated due to the above-mentioned time difference and the trace injection amount of the second fluid C2 before injecting the second fluid C2 into the first fluid C1 in all of the wells 211.

In addition, a reaction degree of the first fluid C1 formed in the well 211 into which the second fluid C2 is first injected with the second fluid C2 may be different from a reaction degree of the first fluid C1 of the well 211 into which the second fluid C2 is finally injected with the second fluid C2 due to the above-mentioned time difference.

Further, in the case of directly and individually injecting the second fluid C2 into at least 96 to at most 1,536 wells 211, bubbles may be generated in the first fluid C1 due to the surface tension, which may cause an experimental error.

Therefore, in the case of directly and individually injecting the second fluid C2 into the well 211, reliability and accuracy of the large capacity analysis system may be significantly decreased due to evaporation of the first fluid C1 and a difference in drug reaction which are caused by a difference in the injection time and bubble generation of the well.

However, in the case of using the fluid injection chip 200 according to the exemplary embodiment of the present disclosure, since the second fluid C2 may be simultaneously injected into the plurality of wells 211, the reliability and accuracy of the large capacity analysis system may be significantly improved.

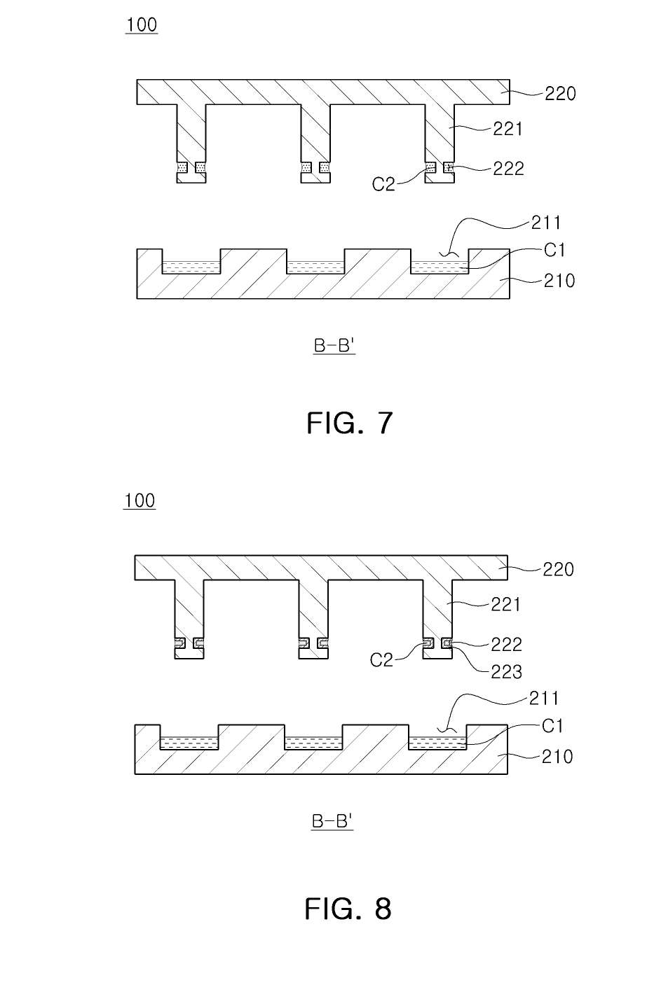

FIG. 9 is a schematic cross-sectional view of a fluid injection chip 200 according to the exemplary embodiment of the present disclosure, further including a vibration member 230.

The vibration member 230 may be formed on an upper surface of the second substrate 220.

The vibration member 230 may be formed of a material capable of generating vibrations.

More specifically, the vibration member 230 may be formed using an ultrasonic generator, a piezoelectric material, or the like, but is not limited thereto.

The vibration member 230 may generate vibrations in the pillar member 221 to thereby more easily inject the second fluid C2 formed in the fluid injection part 222 into the well 211.

In addition, the vibration member 230 may generate vibrations in the pillar member 221 to allow the second fluid C2 to be more suitably dispersed in the well 211 when the second fluid C2 is injected into the first fluid C1 in the well 211.

Therefore, the vibration member 230 may significantly improve the reliability and accuracy of the large capacity analysis system.

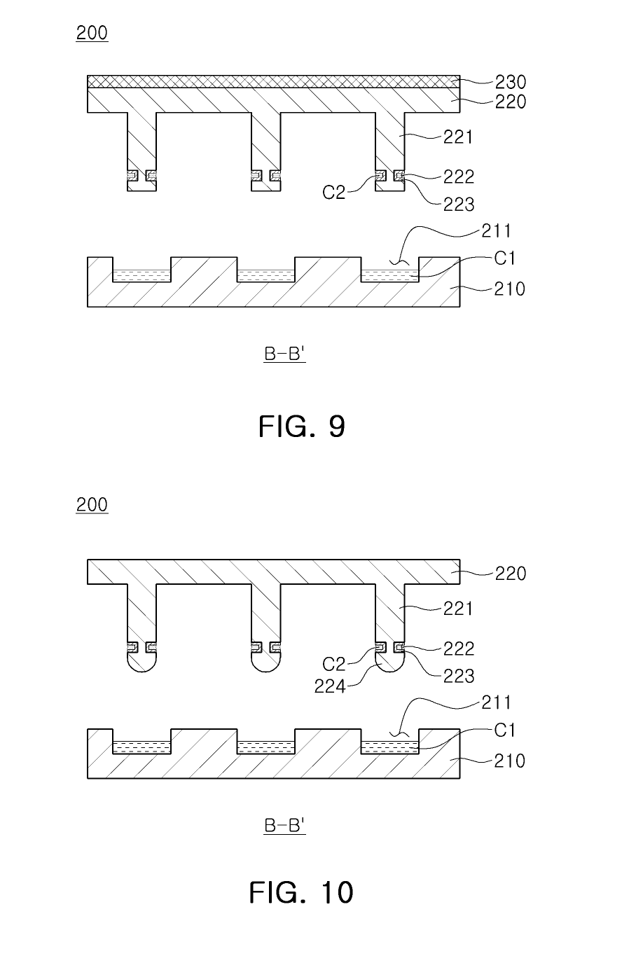

FIG. 10 is a schematic cross-sectional view of a fluid injection chip 200 of which a protrusion surface of a pillar member 224 has a curvature.

As shown in FIG. 10, the protrusion surface 224 of the pillar member 221 of the fluid injection chip 200 according to another exemplary embodiment of the present disclosure may have the curvature.

Since the protrusion surface 224 has the curvature, at the time of forming the second fluid C2 in the fluid injection part 222, the amount of the second fluid C2 may be precisely adjusted.

That is, since the protrusion surface has the curvature, the second fluid C2 adhered to a lower portion of the protrusion part 224 may be significantly decreased, such that the reliability and accuracy of the large capacity analysis system may be significantly improved.

As set forth above, in the fluid injection chip according to exemplary embodiments of the present disclosure, the trace amount of fluid may be simultaneously injected into the plurality of wells without the time difference by forming the low adhesive layer on the protrusion surface of the pillar member.

In addition, the fluid injection chip according to the exemplary embodiment of the present disclosure further includes the vibration member, whereby the fluid may be more rapidly dispersed into the plurality of wells.

While exemplary embodiments have been shown and described above, it will be apparent to those skilled in the art that modifications and variations could be made without departing from the spirit and scope of the present disclosure as defined by the appended claims.

What is claimed is:

1. A fluid injection chip comprising:
a first substrate in which a plurality of wells are formed;
a first fluid formed in the wells;
a second substrate of which a plurality of pillar members are formed on a lower surface so as to correspond to the wells;
a low adhesive layer formed on a protrusion surface of the pillar member; and
a second fluid formed on the low adhesive layer.

2. The fluid injection chip of claim 1, further comprising a vibration member formed on an upper surface of the second substrate.

3. The fluid injection chip of claim 1, wherein the low adhesive layer is formed of a hydrophobic material.

4. The fluid injection chip of claim 1, wherein the second fluid is simultaneously injected into the plurality of wells.

5. A fluid injection chip comprising:
a first substrate in which a plurality of wells are formed;
a first fluid formed in the wells;
a second substrate of which a plurality of pillar members are formed on a lower surface so as to correspond to the wells;
a fluid injection part formed in a side surface of the pillar member; and
a second fluid formed in the fluid injection part.

6. The fluid injection chip of claim 5, further comprising a vibration member formed on an upper surface of the second substrate.

7. The fluid injection chip of claim 5, further comprising a low adhesive layer formed on a surface of the fluid injection part.

8. The fluid injection chip of claim 7, wherein the low adhesive layer is formed of a hydrophobic material.

9. The fluid injection chip of claim 5, wherein a protrusion surface of the pillar member has a curvature.

10. The fluid injection chip of claim 5, wherein the second fluid is simultaneously injected into the plurality of wells.

11. A fluid injection chip comprising:
a first substrate in which a plurality of wells are formed;
a first fluid formed in the wells;
a second substrate of which a plurality of pillar members are formed on a lower surface so as to correspond to the wells; and
a second fluid formed on the low adhesive layer,
wherein the pillar member is formed of a hydrophobic material.
